(19) United States
(12) Patent Application Publication
(10) Pub. No.: US 2002/0013222 A1
(43) Pub. Date: Jan. 31, 2002

(54) Boron nitride supporting type noble metal catalysts

(76) Inventors: Min-Hon Rei, Taipei (TW); Chi-Sheng Wu, Taipei (TW); Zhi-An Lin, Junghe City (TW); Jen-Wei Pan, Taipei (TW)

Correspondence Address: BEVER HOFFMAN & HARMS, LLP, 2099 GATEWAY PLACE, SUITE 320, SAN JOSE, CA, 951101017

(21) Appl. No.: 09/777,488

(22) Filed: Feb. 5, 2001

(30) Foreign Application Priority Data
Jun. 21, 2000 (TW) 89112230

(51) Int. Cl. B01J 21/02; B01J 27/24

(52) U.S. Cl. 502/200; 502/202; 502/207

(57) ABSTRACT

Noble metal catalysts supported by the boron nitride (BN) to be used for oxidizing the volatile organic compound (VOC) are provided. The noble metal is selected from a group consisting of platinum (Pt), palladium (Pd), rhodium (Rh) and Ruthenium (Ru). The process for forming the catalyst includes steps of dissolving a noble metal complex compound in an organic solvent for forming a solution, mixing the solution with the boron nitride (BN) for forming a wetted boron nitride (BN) such that the noble metal complex compound is spread on a surface of the boron nitride (BN), and reducing the noble metal complex on the surface of the wetted boron nitride (BN) into the noble metal at a specific temperature by a gas.

### FIELD OF THE INVENTION

The present invention is related to a noble metal catalyst, and more particularly to a boron nitride (BN) supporting type noble metal catalyst.

### BACKGROUND OF THE INVENTION

It's well known that volatile organic compounds (VOCs) existing in the air are not only to easily result in environmental pollution but also harmful to the human health. Generally, volatile organic compounds (VOCs) include the discharged gas produced by the automobiles and motorcycles, volatilized gasoline from the gas station, volatile organic solvent applied in the industry or our life, and so on. For example, because of low boiling point of benzene-toluene-xylene (BTX) ranging from 80 to 140° C., it's expectable that it would be easy for the benzene-toluene-xylene (BTX) to be volatilized.

In General, volatile organic compounds (VOCs) in the air can be decreased by treating which via the catalytic oxidization method. According to the prior art, although conventional metal oxide supporting type noble metal catalyst, such as Pt/Al₂O₃, is commonly applied in the catalytic oxidization method, there are some disadvantages described as follows.

(a) The volatile organic compounds (VOCs) concentration in the air ranging from 1000 to 2000 ppm is so low that the oxidization efficiency is limited.

(b) Owing to high oxidization temperature, it's easy for the conventional metal oxide supporting type noble metal catalyst to decay its activity.

(c) The oxidization temperature is so high that much more energy would be consumed according to the prior art.

(d) Because of high hydrophilic property of the metal oxide support, moisture is so easily condensed inside the holes of the metal oxide support that the surface of the noble metal is covered by the moisture, and thus the oxidization efficiency is decreased.

(e) The oxidization efficiency of the conventional metal oxide supporting type noble metal catalyst would gradually decrease as which is sequently used for several times.

Accordingly, the present invention focuses on solving the problems encountered in the prior arts as described above.

### SUMMARY OF THE INVENTION

An object of the present invention is to provide a boron nitride supporting type noble metal catalyst for oxidizing volatile organic compounds (VOCs) at lower temperature.

Another object of the present invention is to provide a boron nitride supporting type noble metal catalyst for oxidizing volatile organic compounds (VOCs) without losing activity thereof.

A further object of the present invention is to provide a boron nitride supporting type noble metal catalyst for oxidizing volatile organic compounds (VOCs) with high thermal conductivity.

According to one aspect of the present invention, the present invention is related to a noble metal catalyst supported by the boron nitride (BN) to be used for oxidizing the volatile organic compound (VOC).

Preferably, a specific surface area of the boron nitride (BN) is ranging from 1 to 100 m²/g.

Preferably, a loading of the noble metal is ranging from 0.1 to 5.0 wt %.

Preferably, the noble metal is selected from a group consisting of platinum (Pt), palladium (Pd), rhodium (Rh) and Ruthenium (Ru).

Preferably, the volatile organic compound (VOC) is a C1˜C8 organic compound.

Preferably, the oxidization is a deep oxidization.

Preferably, the volatile organic compound (VOC) is oxidized at a volatile organic compound concentration ranging from 100 ppmv to 10000 ppmv, a vapor hourly space velocity (VHSV) ranging from 8000 to 40000 h⁻¹ and a temperature ranging from 100 to 600° C.

According to another aspect of the present invention, the present invention is related to a process for forming a boron nitride (BN) supporting type noble metal catalyst, comprising steps of (a) dissolving a noble metal complex compound in an organic solvent for forming a solution, (b) mixing the solution with the boron nitride (BN) for forming a wetted boron nitride (BN) such that the noble metal complex compound is spread on a surface of the boron nitride (BN), and (c) reducing the noble metal complex on the surface of the wetted boron nitride (BN) into the noble metal at a specific temperature by a gas.

Preferably, a specific surface area of the boron nitride (BN) is ranging from 1 to 100 m²/g.

Preferably, the noble metal is selected from a group consisting of platinum (Pt), palladium (Pd), rhodium (Rh) and Ruthenium (Ru).

Preferably, a loading of the noble metal is ranging from 0.1 to 5.0 wt %.

Preferably, the organic solvent is methanol.

Preferably, the gas is selected from a group consisting of nitrogen gas, air, oxygen gas and hydrogen gas and a mixing gas thereof.

Preferably, the specific temperature is ranging from 100 to 600° C.

### BRIEF DESCRIPTION OF THE DRAWING

The present invention may best be understood through the following description with reference to the accompanying drawings, in which:

FIG. 1 is a schematic diagram showing the conversion of the volatilized 95 lead-free gasoline which is deeply oxidized by the Pt/BN-A catalyst and the Pt/Al₂O₃ catalyst;

FIG. 2(a) is a schematic diagram showing the conversion of the dry benzene-toluene-xylene (BTX) which is deeply oxidized by the Pt/BN-A catalyst;

FIG. 2(b) is a schematic diagram showing the conversion of the benzene-toluene-xylene (BTX) which is deeply oxidized by the Pt/BN-A catalyst under 6% water vapor in stream;

FIG. 3 is a schematic diagram showing the conversion of the volatilized 95 lead-free gasoline which is consequently deeply oxidized by the Pt/BN-A catalyst for three times;

FIG. 4 is a schematic diagram showing the conversion of the volatilized 95 lead-free gasoline which is deeply oxidized by the Pt/BN-A catalyst for eighty hours; and

FIG. 5 is a x-ray diffraction (XRD) diagram of the Pt/BN-A catalyst before deep oxidization (or after reducing treatment) and after deep oxidization.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

According to the present invention, a novel noble metal catalyst with the boron nitride (BN) being used as a support is provided. The boron nitride (BN) supporting type noble metal catalyst is used to deeply oxidize volatile organic compounds (VOCs). Preferably, the noble metal is selected from a group consisting of platinum (Pt), palladium (Pd), rhodium (Rh) and Ruthenium (Ru). Boron nitride (BN) is a compound of white flake-type powder in appearance. The unique properties of boron nitride include high electrical resistance, extremely thermal stability, chemical inertness, and surface hydrophobicity. Thus, there are several advantages using boron nitride as support in the deep volatile organic compounds (VOCs) oxidation.

(a) The boron nitride support won't be transformed during the high-temperature volatile organic compounds (VOCs) oxidation because of thermal stability and mechanic integrity.

(b) The hot spots caused by volatile organic compounds (VOCs) oxidation can be eliminated due to the high thermal conductivity of boron nitride support, thus, preventing platinum sintering and deactivation.

(c) The active sites of boron nitride support can be easily regenerated by using acidic or basic solutions without corroding boron nitride support because of its chemical inertness.

### Experiment

The above-mentioned advantages of the boron nitride (BN) and the oxidization efficiency and the oxidization result thereof can be proved by an experiment. The procedure and the result of the experiment are described detailedly as follows.

### 1. Preparation Of The Catalyst

The catalyst is prepared by an incipient wetness method. More specifically, 0.0925 grams of H₂PtCl₆·xH₂O, i.e. the weight percentage of platinum is about 40 wt %, is dissolved in suitable amount of methanol first. The prepared solution is then mixed with 10 grams of support by being dropped gradually thereinto. In the experiment, the support includes BN-A provided by High Performance Materials, Inc., BN-B provided by Kojundo, Japan and γ-Al₂O₃.

The catalyst, which is prepared by incipient wetness method, with BN-A being used as the support is designated as Pt/BN-A after which is reduced by a mixing gas (H₂:N₂=1:4) at 300° C. for two hours. The catalyst, which is prepared by incipient wetness method, with BN-B being used as the support is designated as Pt/BN-B after which is reduced by a mixing gas (H₂:N₂=1:4) at 300° C. for two hours. The catalyst, which is prepared by incipient wetness method, with γ-Al₂O₃ being used as the support is designated as Pt/Al₂O₃ after which is reduced by a mixing gas (H₂:N₂=1:4) at 300° C. for two hours.

### 2. Deep Oxidization

The Pt/BN-A catalyst and the Pt/Al₂O₃ catalyst deeply oxidize the dry or wet (6 wt % water) inputting sample at a sample concentration of 100˜10000 ppmv, the vapor hourly space velocity (VHSV) of 20000h⁻¹ and the temperature of 100˜600° C . The volatilized 95 lead-free gasoline and the volatilized benzene-toluene-xylene (BTX) are used as the inputting sample in the deep oxidization step. In the experiment, the conversion of the inputting sample is defined as

Conversion(%) [1−(C_{R0}/C_{Rl})]×100%

wherein C_{Ri} is the entrance concentration of the inputting sample, and C_{R0} is the exit concentration of the inputting sample.

### 3. Result Of The Experiment

Please refer to Table 1 which shows the specific surface area of the Pt/BN-A catalyst, the Pt/BN-B catalyst and the Pt/Al₂O₃ catalyst measured before which proceed deep oxidization. The respectively measured specific surface area of the Pt/BN-A catalyst, the Pt/BN-B catalyst and the Pt/Al₂O₃ catalyst are 70, 2 and 99 m²/g. Because of low specific surface area of the Pt/BN-B catalyst (2 m²/g), the effective reacting area of the noble metal is so little that oxidization efficiency would be very low. Therefore, only the Pt/BN-A catalyst and the Pt/Al₂O₃ catalyst proceed deep oxidization.

TABLE 1
Specific surface area of the Pt/BN-A catalyst, the Pt/BN-B
catalyst and the Pt/Al₂O₃ catalyst measured before
which respectively proceed deep oxidization.

| Catalyst | Specific Surface Area (m₂/g) |
|---|---|
| Pt/BN-A | 70 |
| Pt/BN-B | ˜2 |
| Pt/Al₂O₃ | 99 |

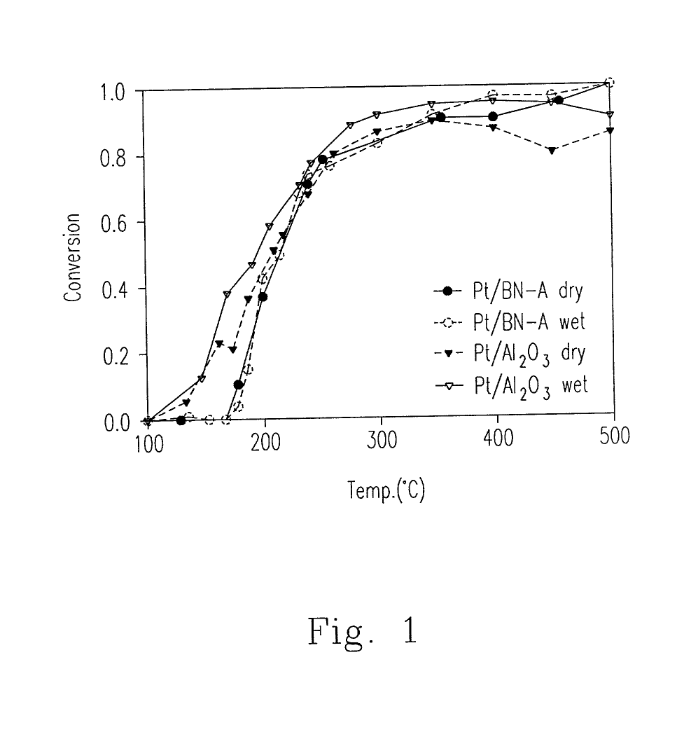

Please refer to FIG. 1 which is a schematic diagram showing the conversion of the volatilized 95 lead-free gasoline which is deeply oxidized by the Pt/BN-A catalyst and the Pt/Al₂O₃ catalyst. For the temperature below 350° C., the conversion of the volatilized 95 lead-free gasoline deeply oxidized by the Pt/BN-A catalyst and that deeply oxidized by the Pt/Al₂O₃ catalyst are not significantly distinguishable. However, for the temperature over 350° C. , the conversion of the volatilized 95 lead-free gasoline deeply oxidized by the Pt/BN-A catalyst and that deeply oxidized by the Pt/Al₂O₃ catalyst are gradually distinguishable. This is because that the thermal conductivity of the alumina (Al₂O₃) is so poor that it's easy for the platinum to be sintered at high temperature and plural hot spots are thus produced such that the activity of the Pt/Al₂O₃ catalyst is lowered, and the surface of the platinum is covered by the alumina (Al₂O₃) such that the activity of the Pt/Al₂O₃ catalyst is lowered. On the contrary, because of high thermal conductivity of the boron nitride (BN), it's not easy for the platinum to be sintered at high temperature and thus plural hot spots are not produced. Certainly, the activity of the Pt/BN-A catalyst would not be lowered, and therefore the conversion of the volatilized 95 lead-free gasoline would increase with increasing oxidization temperature.

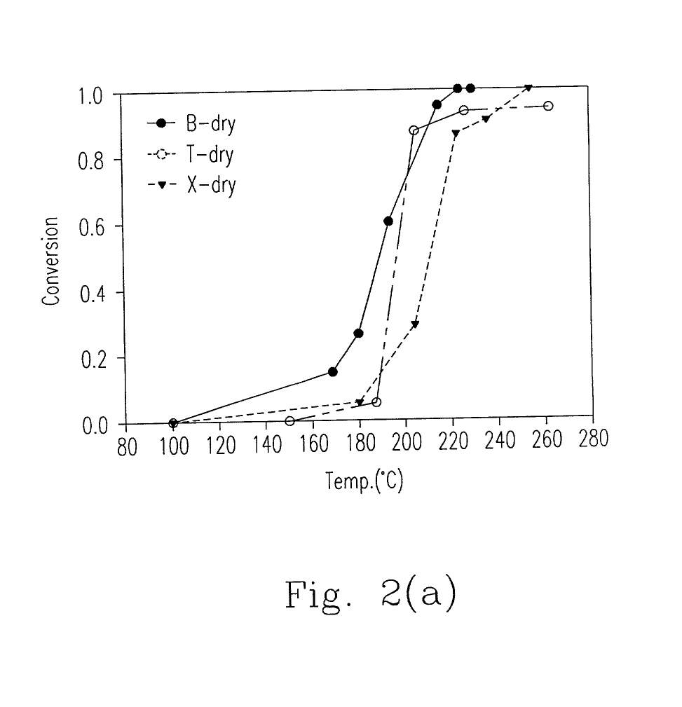

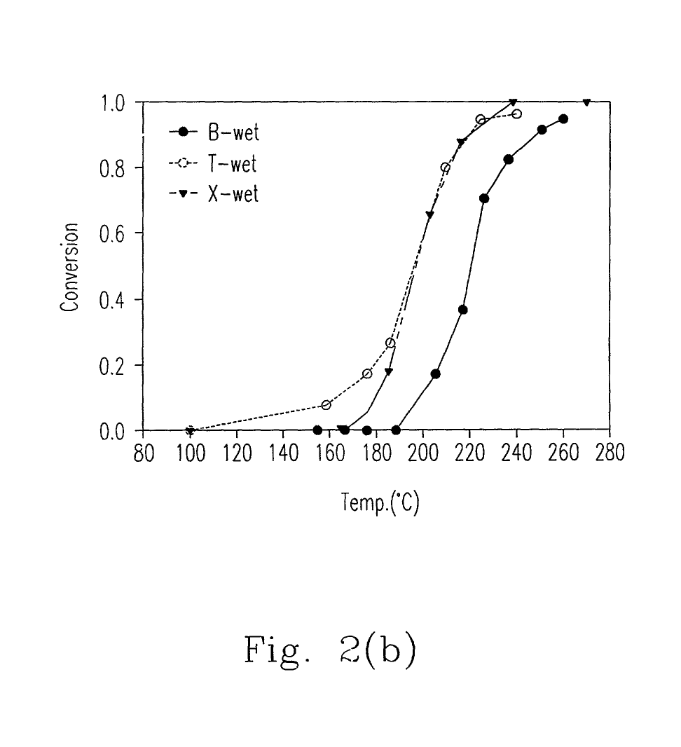

Please refer to FIG. 2(a) and FIG. 2(b) which are schematic diagrams respectively showing the conversion of the dry and the wet benzene-toluene-xylene (BTX) which are both deeply oxidized by the Pt/BN-A catalyst. When the benzene-toluene-xylene (BTX) doesn't contain water, the light-off temperature, that is the temperature corresponding to the conversion of 50%, thereof are around 200° C., which is lower than the light-off temperature thereof by using conventional metal oxide as the support. When the benzene-toluene-xylene (BTX) contains water, the light-off temperature thereof are around 210° C., which is also lower than the light-off temperature thereof by using conventional metal oxide as the support.

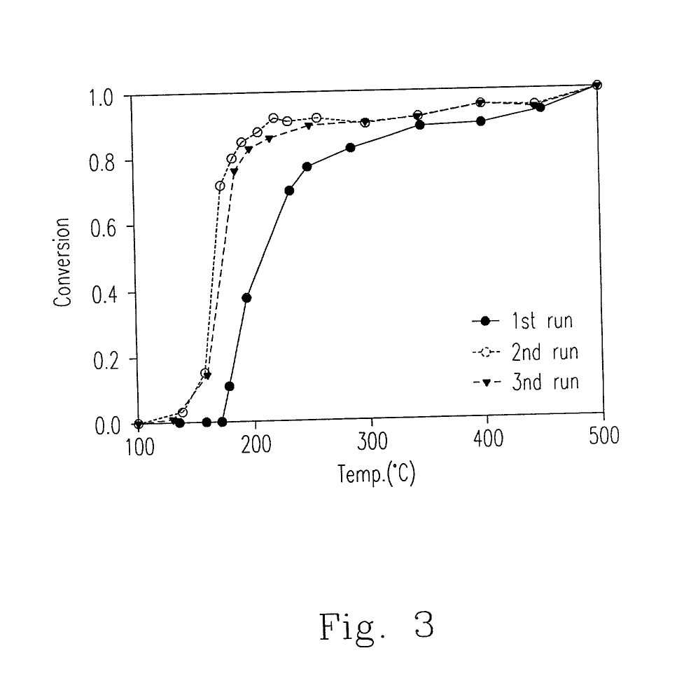

Please refer to FIG. 3 which is a schematic diagram showing the conversion of the volatilized 95 lead-free gasoline which is consequently deeply oxidized by the Pt/BN-A catalyst for three times. Because of high thermal conductivity of the boron nitride (BN), the activity of the Pt/BN-A catalyst doesn't decay. On the contrary, the activity of the Pt/BN-A catalyst gets higher and higher after the volatilized 95 lead-free gasoline is consequently deeply oxidized thereby for three times. Particularly, the conversion of the volatilized 95 lead-free gasoline exceeds 90% at 250° C. This is because that the surface of the Pt/BN-A catalyst is cleaned or the platinum clusters is oxidized to transform into PtₓO_{y}, which is much more active, after the first run of deep oxidization.

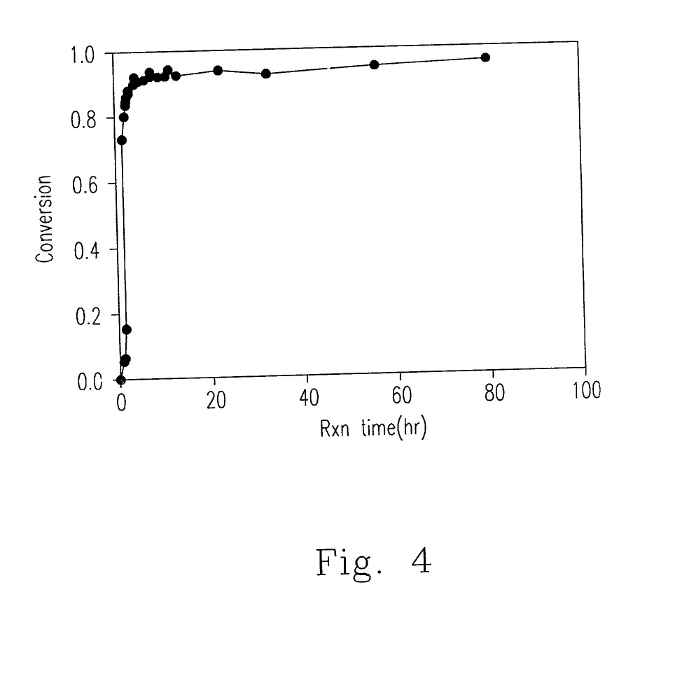

Please refer to FIG. 4 which is a schematic diagram showing the conversion of the volatilized 95 lead-free gasoline which is deeply oxidized by the Pt/BN-A catalyst for eighty hours. It's shown that the activity of the Pt/BN-A catalyst doesn't decay after a long term deep oxidization. This is because that the platinum is not sintered because of high thermal conductivity of the boron nitride (BN).

Please refer to Table 2 which shows the difference between the catalyst before deep oxidization and that after deep oxidization. No matter whether the boron nitride (BN) or the γ-Al₂O₃ catalyst is used as the support, the loading of the platinum after deep oxidization is almost the same to that before deep oxidization, and thus it is shown that the platinum is not lost during deep oxidization. On the other hand, the specific surface area of the Pt/BN-A catalyst before deep oxidization is almost the same to that after deep oxidization, and the specific surface area of the Pt/Al₂O₃ catalyst after deep oxidization is lower than that before deep oxidization. It is further proved that the platinum is sintered during deep oxidization, and thus the activity of the Pt/Al₂O₃ catalyst would be expectably decayed.

TABLE 2
Difference between the catalyst before deep oxidization and
that after deep oxidization.

| | Pt/BN-A | Pt/Al₂O₃ |
|---|---|---|
| Loading Of Platinum Before Deep | 0.30 | 0.29 |
| Oxidization (wt %) | | |
| Loading Of Platinum After Deep | 0.29 | 0.28 |
| Oxidization (wt %) | | |
| Specific Surface Area Before Deep | 70 | 99 |
| Oxidization (m²/g) | | |
| Specific Surface Area After Deep | 69 | 84 |
| Oxidization (m²/g) | | |

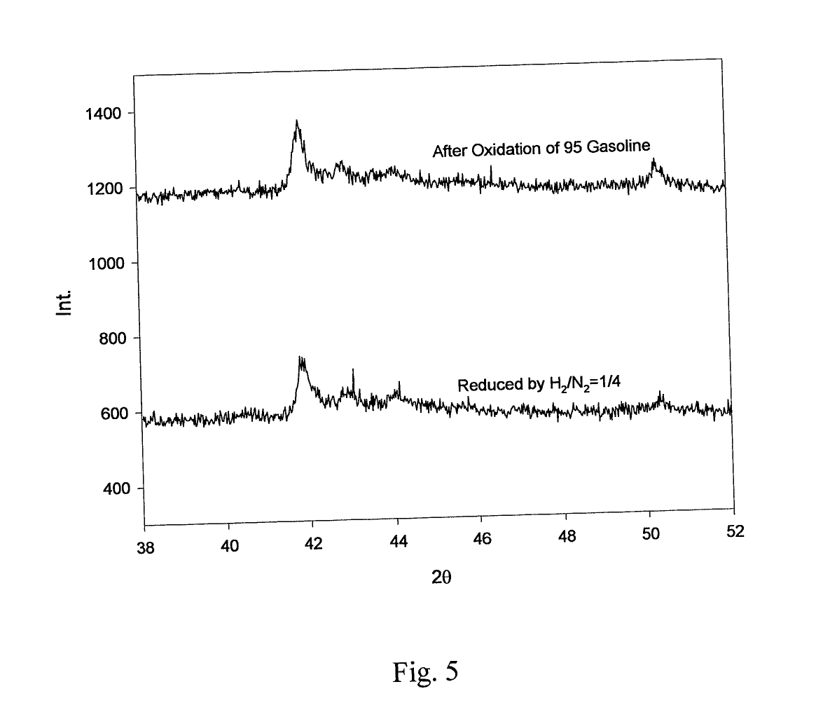

Please refer to FIG. 5 which is a x-ray diffraction (XRD) diagram of the Pt/BN-A catalyst before deep oxidization (or after reducing treatment) and after deep oxidization. If there are two absorption peaks at 2θ=39.5° and 2θ=46° detected after deep oxidization, then the platinum must be sintered during deep oxidization. According to the x-ray diffraction (XRD) diagram, there is not any diffraction peak detected at 2θ=39.5° or 2θ=46° after deep oxidization, and therefore it's shown that the platinum is spread smoothly on the surface of the boron nitride (BN) and thus the platinum is not sintered during deep oxidization.

Though the boron nitride (BN) is used as the support and the platinum is used as the noble metal in the experiment, the noble metal selected from a group consisting of platinum (Pt), palladium (Pd), rhodium (Rh) and Ruthenium (Ru) can be supported on the surface of the boron nitride (BN) according to the present invention. As described above, because the boron nitride (BN) has the advantages of high thermal stability, high thermal conductivity, stable chemical property and good hydrophobic property, the problems encountered in the prior arts are thus solved.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A noble metal catalyst supported by the boron nitride (BN) to be used for oxidizing the volatile organic compound (VOC).

2. The catalyst according to claim 1, wherein a specific surface area of said boron nitride (BN) is ranging from 1 to 100 m²/g.

3. The catalyst according to claim 2, wherein a loading of said noble metal is ranging from 0.1 to 5.0 wt %.

4. The catalyst according to claim 1, wherein said noble metal is selected from a group consisting of platinum (Pt), palladium (Pd), rhodium (Rh) and Ruthenium (Ru).

5. The catalyst according to claim 1, wherein said volatile organic compound (VOC) is a C1˜C8 organic compound.

6. The catalyst according to claim 1, wherein said oxidization is a deep oxidization.

7. The catalyst according to claim 6, wherein said volatile organic compound (VOC) is oxidized at a volatile organic compound concentration ranging from 100 ppmv to 10000 ppmv, a vapor hourly space velocity (VHSV) ranging from 8000 to 40000 h⁻¹ and a temperature ranging from 100 to 600° C.

8. A process for forming a boron nitride (BN) supporting type noble metal catalyst, comprising steps of:
(a) dissolving a noble metal complex compound in an organic solvent for forming a solution;
(b) mixing said solution with said boron nitride (BN) for forming a wetted boron nitride (BN) such that said noble metal complex compound is spread on a surface of said boron nitride (BN); and
(c) reducing said noble metal complex on said surface of said wetted boron nitride (BN) into said noble metal at a specific temperature by a gas.

9. The process according to claim 8, wherein a specific surface area of said boron nitride (BN) is ranging from 1 to 100 m²/g.

10. The process according to claim 8, wherein said noble metal is selected from a group consisting of platinum (Pt), palladium (Pd), rhodium (Rh) and Ruthenium (Ru).

11. The process according to claim 10, wherein a loading of said noble metal is ranging from 0.1 to 5.0 wt %.

12. The process according to claim 8, wherein said organic solvent is methanol.

13. The process according to claim 8, wherein said gas is selected from a group consisting of nitrogen gas, air, oxygen gas and hydrogen gas and a mixing gas thereof.

14. The process according to claim 8, wherein said specific temperature is ranging from 100 to 600° C.
